(19) United States
(12) Patent Application Publication
(10) Pub. No.: US 2016/0192320 A1
(43) Pub. Date: Jun. 30, 2016

(54) MOBILE INFORMATION SERVER SYSTEM

(71) Applicants: HENG TI YANG, Taipei (TW); LI HAO YANG, New Taipei (TW)

(72) Inventors: HENG TI YANG, Taipei (TW); LI HAO YANG, New Taipei (TW)

(21) Appl. No.: 14/584,845

(22) Filed: Dec. 29, 2014

(51) Int. Cl. H04W 64/00; H04W 4/02

(52) U.S. Cl. CPC H04W 64/006; H04W 4/021

(57) ABSTRACT

A mobile information server system is installed on mobile devices. When more than two mobile devices are carried by users, each of the mobile devices sends a geographic position and an IP address to a network location server to be stored and updated by the network location server. The network location server further analyzes the geographic position of each of the mobile devices, and sends the geographic positions and the IP addresses of other mobile devices that are nearby the mobile devices to each of the mobile devices, respectively. And then, the mobile devices obtain and display the information published by the other mobile devices through software protocol to accomplish the function of local business service. The network location server delivers the geographic position and the IP address, but not other information, and each of the mobile devices plays a role of an information server.

### BACKGROUND OF THE INVENTION

1. Field of the Invention

The present invention relates to a mobile information server system, and more particularly to a mobile information server system in which one of the mobile devices communicatively links to other mobile devices to read the information of other mobile devices without accessing an information server.

2. Description of the Prior Art

As shown in FIG. 3, a conventional client/server network system is provided. The conventional mainly includes a server 81, a plurality of terminal apparatuses 82 (for example, the laptop computers, the PDA device shown in FIG. 3 or the like), is connected to the server 81 via internet 83, respectively, so that the terminal apparatuses 82 are communicatively linked to each other. However, when the terminal apparatuses 82 send information (personal data, pictures or video messages in the talk texts of an communication application) to each other, the information are firstly stored in a database 84 of the server 81, and then, the terminal apparatuses 82 are able to access the database 84 to download the information; if the information concern to privacy issue, the information may possibly be stolen from the server 81.

And, as shown in FIG. 4, showing a communication link architecture among a plurality of conventional terminals 91. The conventional terminals 91 shown in FIG. 4 are laptop computers, and connections are established between the conventional terminals 91 by using point-to-point (P2P) protocol. Compared to the conventional system disclosed in FIG. 3, in the system provided in FIG. 4, although the server is not necessary for the conventional terminals 91 to access information, the conventional terminals 91 can only suitable to be those devices with fixed IP addresses, and the mobile devices cannot be used.

The present invention is, therefore, arisen to obviate or at least mitigate the above mentioned disadvantages.

### SUMMARY OF THE INVENTION

An object of the present invention is to provide a mobile information server system applicable to the communicative links between mobile devices whose IP addresses are not fixed, and the system prevent private information from being stolen from the conventional server.

To achieve the above and other objects, the mobile information server system comprises an application and a network location server. The application is installed in a mobile device having a database or having storage device. The mobile device comprises a positioning unit installed therein for positioning a geographic position of the mobile device, and the application provides an IP address of the mobile device in which the IP address is configured by a base station having wireless communication service. The network location server is provided to record the geographic position and the IP address of the mobile device. The network location server computes the relative distance between the mobile device and a second mobile device, and the network location server offers the geographic position and the actual IP address of the second mobile device to the mobile device according to a request of position information from the mobile device. When the mobile device is moved along with a user, the mobile device not only provides the geographic position and the IP address of the mobile device to the network location server, but also retrieves the geographic position and the IP address of the second mobile device from the network location server. The mobile device and the second mobile device make requests and feedback information mutually via the application of the mobile device and the application of the second mobile device. Information published by one of the mobile devices is read directly by the other mobile device without accessing the network location server.

In some implementation aspects, the information read by the mobile device is the information of a third mobile device nearby the geographic position of the second mobile device.

In some implementation aspects, the information read by the mobile device is publicly displayed, and the information read by the mobile device is to be browsed by using the application as a display interface.

In some implementation aspects, the information read by the mobile device is an interested personal data in the second mobile device, and the application provides a query function and a response function.

In some implementation aspects, the information to be shared and displayed by the mobile device is editable via the application of the mobile device, the information to be shared or displayed is readable and directly stored in the database or the storage device of the mobile device, so that the second mobile device reads the information to be shared or displayed by the communication link of the network location server, and the information is read through point-to-point protocol.

In some implementation aspects, the more than two devices send messages to each other without accessing the network location server, so that the mobile devices respectively has a communication function to communicate with each other.

In some implementation aspects, the positioning unit is a global positioning system or an assisted global positioning system.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic view showing the communication link architecture of a mobile information server system according to the present invention;

FIG. 2 is a block diagram of a mobile device of the mobile information server system in which the mobile device comprising a database, a positioning server and an application;

FIG. 3 is a schematic view showing a conventional client/server network system; and

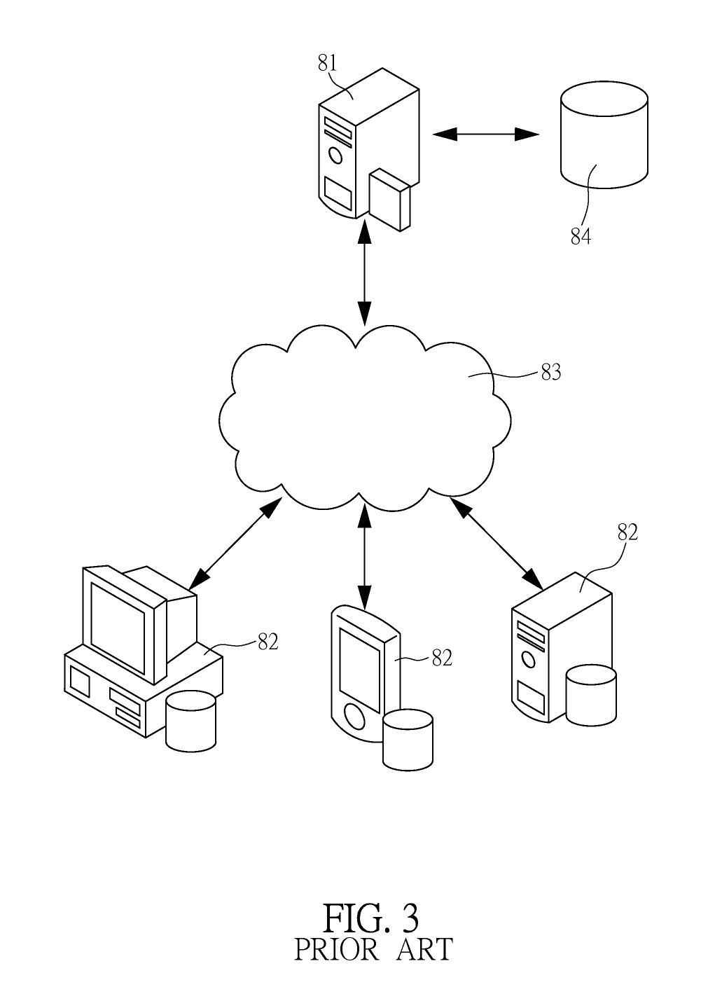

FIG. 4 is a schematic view showing a communication link architecture among a plurality of conventional terminals.

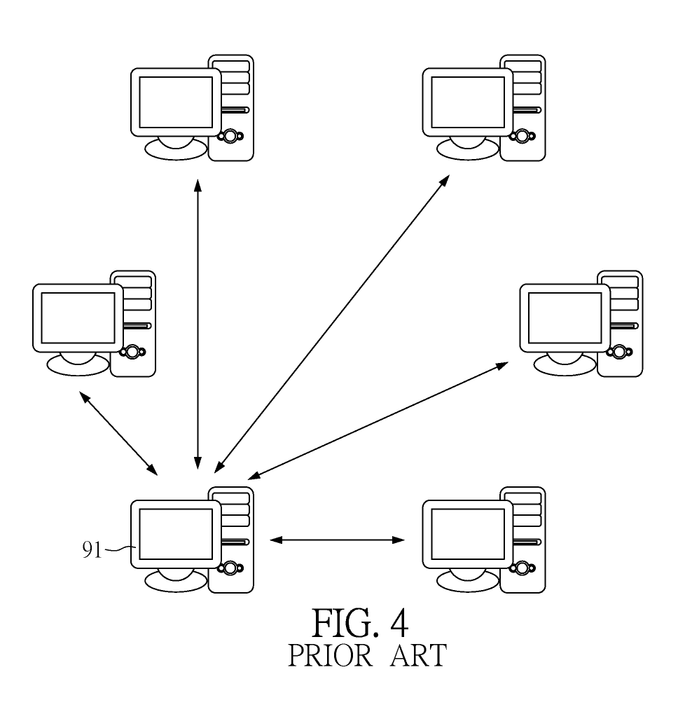

### DETAILED DESCRIPTION OF THE PREFERRED EMBODIMENTS

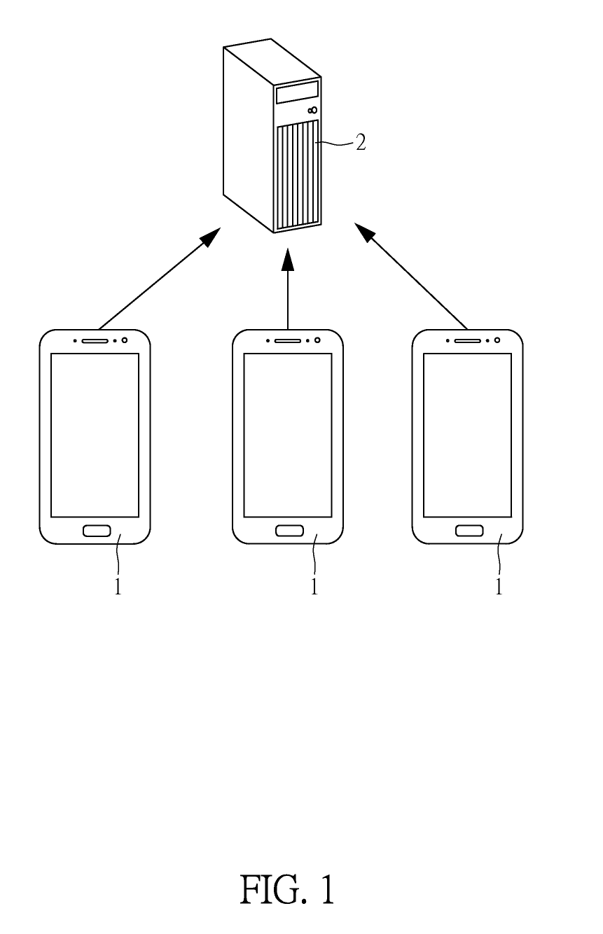

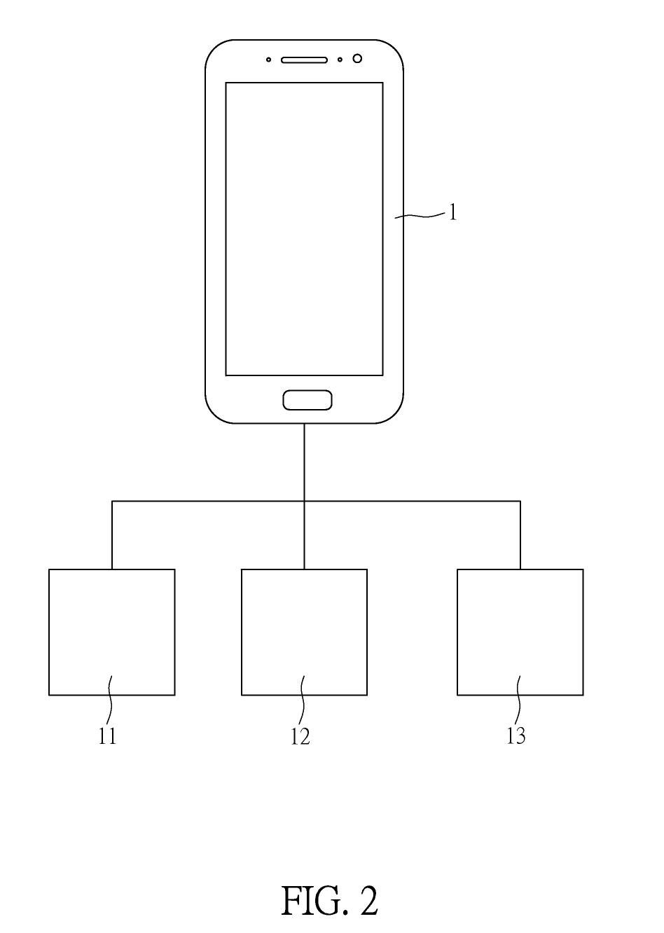

Please refer to FIG. 1 and FIG. 2; illustrating an exemplary embodiment of a mobile information server system according to the present invention. It is realized that the drawings are provided as illustrative purposes, and the scope of the claimed invention is not limited by the drawings.

As shown in FIG. 1 and FIG. 2, in which the mobile information server system comprises a plurality of mobile devices 1 and a network location server 2.

As shown in FIG. 2, each of the mobile devices 1 has a database 11 and a positioning unit 12. The positioning unit 12 is installed in the mobile device 1 for positioning the geographic position of the mobile device 1. An application 13 is installed in each of the mobile devices 1, so that each of the mobile devices 1 provides an IP address configured by a base station having wireless communication service by the application 13. The database 11 can be replaced by a storage device.

The positioning unit 12 can be a global positioning system (GPS) or an assisted global positioning system (AGPS). Here, the positioning unit 12 is an AGPS.

The network location server 2 records the geographic positions and the IP addresses of the mobile devices 1 and computes the relative distances between the mobile devices 1. According to a request of position information from a first mobile device 1, the network location server 2 offers the geographic positions and the actual IP addresses of other mobile devices 1 to the first mobile device 1. The aforementioned base station mainly provides a function of enabling each of the mobile devices 1 having wireless communication service. The base stations of the mobile devices 1 can have the same service provider; alternatively, the service provider of some of the base stations of the mobile devices 1 can be different from the service provider of the rest of the base stations of the mobile devices 1; or, the base stations of the mobile devices 1 can have different service providers.

When a first mobile device 1 is moved along with a user, the first mobile device 1 not only provides the geographic position and the IP address of the first mobile device 1 to the network location server 2, but also retrieves the geographic positions and the IP addresses of other mobile devices 1 from the network location server 2. The mobile devices 1 make requests and feedback information mutually via the applications 13 of the mobile devices 1, and information published by one of the mobile devices 1 can be read directly by other mobile devices 1 without accessing the network location server 2.

In this embodiment, the information to be read by a first mobile device 1 comprises:

1. The information of a third mobile device 1 nearby the geographic position of a second mobile device 1.

2. The information publicly displayed by the second mobile device 1, and is to be browsed by using the application 13 of the first mobile device 1 as a display interface.

3. An interested personal data in the second mobile device 1, and the application 13 of the first mobile device 1 provides a query function and a response function.

Furthermore, in this embodiment, the user can edit the information to be shared and displayed by the mobile device 1 via the application 13, the information to be shared or displayed is readable and directly stored in the database 11 of the mobile device 1, so that the second mobile device 1 reads the information to be shared or displayed by a communication link of the network location server 2, and the information is read through point-to-point protocol.

For example, in a case that the owner of a first mobile device 1 is a store and the owner of a second mobile device 1 is a customer. Since both of the mobile devices 1 has the application 13, the geographic position and the IP address of each of the mobile devices 1 can be retrieved from the network location server 2, so that the mobile devices 1 can communicatively link to each other during the mobile devices 1 are moving along with the owners. In the case that merchandise/service information are stored in the database 11 of the first mobile device 1 by the store, if the customer wants to query the merchandise/service information, the customer can directly link to, via the second mobile device 1, the database 11 or the storage device of the first mobile device 1 so as to read the information such as the merchandise/service descriptions, the merchandise/service photographs, the introduction videos of the merchandise/service, and so on.

Here, the owner of each of the mobile devices 1 has a maximum control authority to the information he/she provided. The owner can directly, at his/her will, to turn on/off the mobile device 1, to activate/deactivate the information providing service, and so on. The executions of the aforementioned actions do not limited by the network location server 2 or other servers. In the present invention, each of the mobile devices 1 plays a role of an information server for other mobile devices 1.

It can be realized that, according to the mobile information server system, the network location server 2 is built to store the geographic position of each of the mobile devices 1. When one mobile device 1 is moved along with the owner, the mobile device 1 updates the geographic position thereof via the positioning unit 12 and sends the geographic position to the network location server 2, so that the mobile devices 1 can communicatively link to each other continuously. Furthermore, the mobile devices 1 directly read the information from each other without accessing the network location server 2. The problem of information being stolen from the server thus can be prevented, and the private information of the user owning the mobile device 1 can be protected from being released.

Furthermore, the mobile information server system according to the present invention also provides a location based service (LBS) which is not a stationary LBS, but a mobile LBS.

Although particular embodiments of the invention have been described in detail for purposes of illustration, various modifications and enhancements may be made without departing from the spirit and scope of the invention. Accordingly, the invention is not to be limited except as by the appended claims.

1. A mobile information server system, comprising:
an application, installed in a mobile device having a database or having a storage device, the mobile device comprising a positioning unit installed therein for positioning a geographic position of the mobile device, and the application providing an IP address configured by a base station having wireless communication service; and
a network location server, provided to record the geographic position and the IP address of the mobile device, and the network location server computing the relative distance between the mobile device and a second mobile device, the network location server offering the geographic position and the actual IP address of the second mobile device to the mobile device according to a request of position information from the mobile device;
wherein, when the mobile device is moved along with a user, the mobile device not only provides the geographic position and the IP address of the mobile device to the network location server, but also retrieving the geographic position and the IP address of the second mobile device from the network location server, the mobile device and the second mobile device make requests and feedback information mutually via the application of the mobile device and the application of the second mobile device, and information published by one of the mobile devices is read directly by the other mobile device without accessing the network location server.

2. The mobile information server system according to claim 1, wherein the information read by the mobile device is the information of a third mobile device nearby the geographic position of the second mobile device.

3. The mobile information server system according to claim 1, wherein the information read by the mobile device is publicly displayed, and the information read by the mobile device is to be browsed by using the application as a display interface.

4. The mobile information server system according to claim 1, wherein the information read by the mobile device is an interested personal data in the second mobile device, and the application provides a query function and a response function.

5. The mobile information server system according to claim 1, wherein the information to be shared and displayed by the mobile device is editable via the application of the mobile device, the information to be shared or displayed is readable and directly stored in the database or the storage device of the mobile device, so that the second mobile device reads the information to be shared or displayed by the communication link of the network location server, and the information is read through point-to-point protocol.

6. The mobile information server system according to claim 1, wherein the positioning unit is a global positioning system or an assisted global positioning system.
